(19) United States
(12) Patent Application Publication
(10) Pub. No.: US 2024/0092638 A1
(43) Pub. Date: Mar. 21, 2024

(54) OXYFUEL COMBUSTION IN METHOD OF RECOVERING A HYDROGEN-ENRICHED PRODUCT AND CO2 IN A HYDROGEN PRODUCTION UNIT

(71) Applicant: UOP LLC, Des Plaines, IL (US)

(72) Inventors: Glen Pomorski, Park Ridge, IL (US); Bradley Russell, Fall Branch, TN (US); Carl J. Stevens, Deerfield, IL (US)

(21) Appl. No.: 18/469,814

(22) Filed: Sep. 19, 2023

Related U.S. Application Data
(60) Provisional application No. 63/376,392, filed on Sep. 20, 2022.

(51) Int. Cl. C01B 3/56; B01D 53/00; B01D 53/047; B01D 53/26; C01B 3/32; C01B 32/50

(52) U.S. Cl. CPC C01B 3/56; B01D 53/002; B01D 53/047; B01D 53/265; C01B 3/323; C01B 32/50; B01D 2256/16; B01D 2256/22; B01D 2257/102; B01D 2257/11; B01D 2257/502; B01D 2257/504; B01D 2257/7025; B01D 2257/80; C01B 2203/0244; C01B 2203/0425; C01B 2203/047; C01B 2203/0475; C01B 2203/048; C01B 2203/0827; C01B 2203/1235; C01B 2203/146; C01B 2203/84

(57) ABSTRACT

Methods of producing a hydrogen-enriched product and recovering CO₂ are described. A synthesis gas stream from a hydrogen production process unit is separated in a hydrogen pressure swing adsorption unit into a high-pressure hydrogen stream and a hydrogen depleted tail gas stream, and the hydrogen depleted tail gas stream is compressed. The compressed tail gas stream is separated in a CO₂ fractionation system into a CO₂-enriched product stream and an overhead stream. The overhead stream is separated in an overhead hydrogen PSA system into a second high-pressure hydrogen stream and a low-pressure tail gas stream. The first and second high-pressure hydrogen streams and the CO₂-enriched product stream are recovered. The low-pressure tail gas stream from the overhead hydrogen PSA system is combusted with oxygen to produce steam, electricity, or both.

### RELATED APPLICATIONS

This application claims priority to U.S. Provisional Patent Application Ser. No. 63/376,392, filed on Sep. 20, 2022, the entirety of which is incorporated herein by reference.

### BACKGROUND

Hydrogen is expected to have significant growth potential because it is a clean-burning fuel. However, hydrogen production is traditionally a significant emitter of CO₂, and government regulations and societal pressures are increasingly taxing or penalizing CO₂ emissions or incentivizing CO₂ capture. Consequently, significant competition to lower the cost of hydrogen production while recovering the byproduct CO₂ for subsequent geological sequestration to capture the growing market is anticipated. CO₂ can be recovered as a high-pressure gas to be supplied to a pipeline, but often it is produced in liquefied form for easy transport by truck or ship due to the current lack of CO₂ pipeline infrastructure in certain areas of the world.

There is increasing interest in minimizing CO₂ emissions from hydrogen production processes based on steam reforming, autothermal reforming, partial oxidation, or gasification of hydrocarbon or carbonaceous feedstocks. A method for achieving this objective is to add CO₂ capture to the process along with conversion of unconverted carbon-containing components (carbon monoxide and methane) to carbon dioxide within the process. Ideally, all of the unreacted carbon-containing components (carbon monoxide and methane) from the hydrogen production process are converted to carbon dioxide by oxyfuel combustion with capture of the resulting CO₂ within the carbon capture section of the process. However, the presence of inert components such as nitrogen and argon in the hydrocarbon or carbonaceous feedstocks or the oxygen feedstock to such processes poses a problem with this approach. These inert components build up in the process and must be purged from the system, typically as a fuel gas stream. This purge stream also comprises carbon-containing components (carbon dioxide, carbon monoxide, and methane) and results in carbon emissions to the atmosphere. Therefore, a method is needed to purge inert components efficiently and selectively from the process without increasing carbon emissions.

Most existing hydrogen production processes utilize pressure swing adsorption (PSA) to recover high-purity product hydrogen from shifted syngas. The low-pressure tail gas stream from the PSA unit is typically combusted to generate heat for the process. If no stream is sent to a combustor, a purge is required to prevent the build-up of inert gases in the process.

U.S. Pat. No. 8,021,464 describes a process for the combined production of hydrogen and CO₂ from a mixture of hydrocarbons which are converted to syngas. The syngas is separated in a PSA unit into a hydrogen-enriched stream and a PSA off gas stream. The PSA off gas is compressed and dried, followed by several successive steps of condensing and separating the CO₂-rich condensate with the temperature being reduced at each step, the temperature ranging from ambient to −56° C. However, the process results in a purge stream containing a significant amount of CO₂ which must be removed from the process. A permeate module can be used to improve the separation, but at the cost of increased power requirements.

U.S. Pat. No. 8,241,400 describes a process for recovering hydrogen and CO₂ from a mixture of hydrocarbons utilizing a system that includes a reformer unit, an optional water gas shift reactor, a PSA unit, and a cryogenic purification unit or a catalytic oxidizer. The PSA unit produces three streams: a high-pressure hydrogen stream, a low-pressure CO₂ stream, and a CH 4 rich stream which is withdrawn during a CO₂ co-purge step and which may be recycled to the reformer unit. Purified CO₂ from the CO₂ purification unit in the process is used as the co-purge in the PSA unit. The adsorption step is run at a pressure of about 250 psig to about 700 psig. The pressure during the co-purge step is in the range of about 300 psig to about 800 psig, and the CO₂ co-purge stream is preferably introduced at a pressure higher than the pressure during the adsorption step. The use of a second high-pressure feed stream (the CO₂ co-purge stream) increases the cost and complexity of the process. The necessity of having a segmented adsorber (or two separate vessels) with an isolation valve between the two and an intermediate side-draw further increases the cost and complexity of the process.

WO 2021/175662 describes a hydrogen production process based on reforming of hydrocarbon feedstocks wherein hydrogen and CO₂ are recovered from the process. A rest gas comprising unreacted carbon-containing components is recycled within the process. As noted above, a problem with this approach is the carbon emissions created by purging inert components (argon and/or nitrogen) from the recycle loop.

No hydrogen production facility has 100% conversion of the hydrocarbon feedstock to hydrogen, and these unconverted hydrocarbons lead to additional carbon emissions from the process, which add to the carbon intensity of the hydrogen facility. Hydrogen facilities with carbon capture require large quantities of heat for the reforming reaction as well as work in the form of steam or electricity to drive the numerous compressors required to sequester the captured CO₂. The electricity and fuel requirements often lead to increases in the carbon intensity and therefore, limit the profitability of the technology.

Therefore, there is a need for improved hydrogen production processes with reduced carbon intensity.

### BRIEF DESCRIPTION OF THE DRAWINGS

FIG. 1 is an illustration of a low carbon-intensity process for producing a hydrogen stream and recovering carbon dioxide from a hydrogen production process with generation of steam by oxyfuel combustion.

FIG. 2 is an illustration of another embodiment of a low carbon-intensity process for producing a hydrogen stream and recovering carbon dioxide from a hydrogen production process with generation of steam by oxyfuel combustion.

FIG. 3 is an illustration of another embodiment of a low carbon-intensity process for producing a hydrogen stream and recovering carbon dioxide from a hydrogen production process with generation of steam by oxyfuel combustion.

### DETAILED DESCRIPTION

The present processes are unique because they utilize oxygen from the air separation unit and off gas from the process, as well as supplemental natural gas or other supplemental hydrocarbon containing fuel, for oxyfuel combustion in a way that allows for the existing carbon capture equipment to be utilized to reduce or eliminate all direct process carbon emissions from the plant. In addition, the oxyfuel combustion allows for generation of steam and electricity required by the rest of the process, further reducing or eliminating the carbon intensity. This allows for higher credits for reduced carbon emissions (or clean hydrogen) to be awarded to the production facility, making the unit more profitable.

The combustion gases, which are almost entirely CO₂ and water vapor, can be directed to the suction of the hydrogen PSA tail gas compressor-and mixed with the CO₂-enriched process stream from the hydrogen production process. Carbon dioxide from the combustion gases is then captured utilizing the same equipment as the process carbon capture system. Processes for CO₂ capture can include cryogenic fractionation, amine solvents, or CO₂ PSA.

In some embodiments, oxygen from an air separation unit (ASU) is combined with off gas from the process and any additional methane/natural gas fuel and combusted to generate steam and in turn electricity for the power requirements of the units in the process.

A feed stream comprising hydrocarbons or a carbonaceous feedstock is processed in a hydrogen production process unit. Suitable hydrogen production processes include, but are not limited to, a steam reforming unit with an optional gas heated reformer, or an autothermal reforming unit with an optional gas heated reformer, or a gasification unit, or a partial oxidation (PDX) unit, or combinations thereof.

The synthesis gas mixture produced in the hydrogen production process comprises hydrogen, carbon monoxide, methane, water, and inert gases such as nitrogen and argon. The synthesis gas mixture undergoes a water-gas-shift reaction to convert carbon monoxide to carbon dioxide and additional hydrogen.

The hydrogen concentration in the synthesis gas stream is generally in the range of about 50 mol % to about 80 mol %. For example, the hydrogen concentration in a steam methane reforming plant shifted syngas is about 60 mol % to about 80 mol %, while the hydrogen concentration in a PDX reactor is about 50 mol % to about 70 mol %.

The shifted synthesis gas stream may optionally be cooled, and the water removed in a vapor liquid separator, for example, before entering the hydrogen PSA unit.

The temperature of the incoming feed gas mixture to the hydrogen PSA unit is typically in the range of about 20° C. to about 60° C., or about 30° C. to about 50° C., or about 40° C. (or any combination of temperature ranges).

The shifted synthesis gas is separated in the hydrogen PSA unit into a high-pressure hydrogen product stream and a low-pressure hydrogen-depleted gas stream. The high-pressure hydrogen product stream is recovered. About 80% to 92% of the hydrogen in the synthesis gas mixture to the hydrogen PSA system is typically recovered in the high-pressure product stream, and in some cases, the high-pressure hydrogen stream is substantially free of CO₂, methane, carbon monoxide, nitrogen, and argon. It typically contains less than about 1% of the CO₂ relative to the feed gas mixture, or less than about 0.1%, or less than about 0.01%. It typically contains less than about 10% of the methane, carbon monoxide, nitrogen, and argon relative to the feed gas mixture, or less than about 5%, or less than about 2%, or less than about 1%, or less than about 0.1%. The high-pressure hydrogen product stream is typically removed at a high pressure in the range of about 1,000 to about 6,000 kPa, or about 2,000 kPa to about 5,000 kPa, or about 2,500 kPa to about 4,500 kPa. The high-pressure hydrogen product stream typically comprises greater than 99.0 mol % hydrogen, or greater than 99.9 mol %, or greater than 99.99 mol %.

The low-pressure hydrogen-depleted tail gas stream comprises a portion of the hydrogen, the carbon dioxide, and the at least one of the methane, the carbon monoxide, the water, the nitrogen, and the argon. The hydrogen-depleted tail gas stream is typically removed at a low pressure in the range of about 50 kPa to about 250 kPa, or about 100 kPa to about 200 kPa. The hydrogen-depleted tail gas stream typically contains about 95% to 100% of the CO₂ in the feed gas mixture. It typically contains about 10% of the hydrogen relative to the feed gas mixture (e.g., about 5% to about 15%), and about 70 to 100% of the methane, carbon monoxide, nitrogen, and argon relative to the feed.

The low-pressure hydrogen-depleted tail gas stream may be compressed, dried, and sent to the CO₂ fractionation system where it separated into a CO₂-enriched product stream comprising a first portion of the carbon dioxide and an overhead stream comprising a portion of the hydrogen, a second portion of the carbon dioxide, the second portion being less than the first portion, and the at least one of the methane, the carbon monoxide, the nitrogen, and the argon.

The CO₂-enriched stream is recovered. The CO₂-enriched stream may be a liquid stream. In some cases, the liquid stream may then be vaporized for use, if desired.

The overhead stream is sent to an overhead hydrogen PSA system that produces at least two product streams. The overhead hydrogen PSA system separates the overhead stream into at least two streams: a second high-pressure hydrogen stream, and a low-pressure tail gas stream. The high-pressure hydrogen stream is enriched in hydrogen. The low-pressure tail gas stream is enriched in carbon dioxide. The second high-pressure hydrogen stream is recovered.

The overhead PSA system may comprise a three-product PSA unit, a single two-product PSA unit, or two two-product PSA units in series.

When the overhead hydrogen PSA system comprises a three-product PSA unit, the overhead stream is introduced into the three-product PSA unit to form the high-pressure hydrogen product stream, the carbon-enriched tail gas stream, and a vent gas stream enriched in inert gas.

The three-product PSA unit comprises four or more PSA adsorption vessels. There are generally at least six vessels. The vessels comprise one or more adsorbent layers, generally one to five, and typically two to three. The percentage of the bed for an adsorption layer is typically between 10% and 100%. Different layers of adsorbent have different selectivity to the components in the overhead stream, as is known to those skilled in the art. Some layers contain adsorbent that is for selective adsorption of CO₂ relative to methane, carbon monoxide, nitrogen, argon, and hydrogen, including, but not limited to, layers of activated alumina, activated carbon, silica gel, and sodium Y zeolite. Other layers contain adsorbent that is for selective adsorption of CO₂, methane, carbon monoxide, nitrogen, and argon relative to hydrogen, including, but not limited to, layers of activated carbon, silica gel, and molecular sieve zeolite (e.g., 5A or sodium X zeolite). Those of skill in the art will appreciate that other zeolites could be used and will know how to select appropriate adsorbents.

There is a first opening at one end of the vessel, and a second opening at the opposite end. For convenience, the ends will be referred to as the top and the bottom of the vessel. The first opening at the bottom is selectively connected to a high-pressure feed gas inlet line, and a low-pressure tail gas outlet line. The second opening at the top of the vessel is selectively connected to a high-pressure product outlet line, an intermediate pressure vent gas outlet line, and a low-pressure purge gas inlet line. The feed gas enters at high pressure through the first opening at the bottom of the vessel, and a high pressure, co-current adsorption and product removal step takes place with the product exiting the vessel at high pressure through the second opening at the top of the vessel. There is at least one co-current depressurization step, and then an intermediate pressure co-current depressurization and vent gas removal step. The second stream is removed through the opening at the top of the vessel at a second pressure. There is a counter-current blowdown step and a counter-current purge step. The purge gas enters through the opening at the top of the vessel at low pressure. The CO₂ can be removed at low pressure through the opening at the bottom of the vessel during either or both of the counter-current blowdown step and the counter-current purge step. There is at least one counter-current re-pressurization step following the counter-current purge and tail gas removal step.

When the overhead PSA system comprises at least two PSA units in series, the overhead stream from the CO₂ fractionation system is introduced into the first PSA unit where it is separated into the low-pressure tail gas stream enriched in CO₂, carbon monoxide, and methane (for example, about 80% to 100% recovery of CO₂, carbon monoxide, and methane from the overhead stream) and a high-pressure stream comprising substantially all (e.g. more than 75%, or about 85% to about 95%) of the hydrogen, and a portion (about 50% to about 90%) of the nitrogen, and the argon. The low-pressure tail gas stream has a low pressure of about 50 kPa to about 250 kPa, or about 100 kPa to about 200 kPa. The high-pressure stream has a high pressure in the range of about 1,000 to about 6,000 kPa, or about 2,000 kPa to about 5,000 kPa, or about 2,500 kPa to about 4,500 kPa.

The high-pressure stream from the first PSA unit is fed into the second PSA unit where it is separated into the second high-pressure hydrogen stream containing substantially all the hydrogen (e.g., about 80% to about 90%) and a second low-pressure tail gas stream comprising a portion of the hydrogen (e.g., about 10% to 20%) and a portion of the nitrogen and argon. (e.g., about 20% to 80%). The high-pressure hydrogen stream typically has a high pressure in the range of about 1,000 to about 6,000 kPa, or about 2,000 kPa to about 5,000 kPa, or about 2,500 kPa to about 4,500 kPa.

The first PSA unit contains adsorbent that is for selective adsorption of CO₂ relative to methane, carbon monoxide, nitrogen, argon, and hydrogen, including, but not limited to, layers of activated alumina, silica gel, and sodium Y zeolite. The second PSA unit contains adsorbent that is for selective adsorption of CO₂, methane, carbon monoxide, nitrogen, and argon relative to hydrogen, including, but not limited to, layers of activated carbon, silica gel, and molecular sieve zeolite (e.g., 5A or sodium X zeolite). Those of skill in the art will appreciate that other zeolites could be used and will know how to select appropriate adsorbents for the first and second two-product PSA units.

In some embodiments, the process allows for recovery of about 80 to about 90% of the hydrogen in the tail gas stream from the hydrogen PSA unit, as well as capture of substantially all (e.g., about 95% to about 100%) of the CO₂.

The low-pressure tail gas stream from the overhead PSA system is sent to a first fired heater oxyfuel combustion unit where the methane and carbon monoxide are burned with oxygen to produce steam and/or electricity.

In some embodiments, a natural gas stream, or other hydrocarbon-containing stream, such as liquified petroleum gas, naphtha, or hydrocarbon-containing waste gases, could be sent to the first fired heater as fuel.

The flue gas from the fired heater oxyfuel combustion unit is combined with the hydrogen depleted tail gas stream and sent to the CO₂ fractionation system. A portion of the flue gas can be recycled to control the temperature of the fired heater oxyfuel combustion unit.

The vent gas stream from the overhead three-product PSA unit may be sent to a second fired heater and burned with air to produce steam and/or electricity. Alternatively, the vent gas stream can be sent to a fuel header or simply flared off.

In embodiments with lean burn combustion in the first fired heater oxyfuel combustion unit, oxygen may be removed from the low-pressure hydrogen-depleted compressed tail gas stream from the hydrogen PSA unit before drying the low-pressure hydrogen-depleted tail gas stream. Oxygen removal can be accomplished in either a preferential oxidation unit or a de-oxygenation unit. In both cases, a catalyst be is used to consume oxygen to avoid oxygen entering the CO₂ fractionation system and contaminating the product hydrogen. The preferential oxidation unit uses a platinum or ruthenium catalyst and selectively reacts carbon monoxide with oxygen to minimize hydrogen consumption. Any excess oxygen will consume hydrogen in the preferential oxidation unit. The de-oxygenation unit is non-selective and will consume hydrogen and carbon monoxide. The de-oxygenation catalyst is typically platinum or palladium.

In an alternate embodiment, the synthesis gas stream from the hydrogen production process unit is sent to a hydrogen PSA unit where it is separated into a high-pressure hydrogen stream and a hydrogen-depleted tail gas stream.

The hydrogen-depleted tail gas stream is compressed and sent to a CO₂ PSA unit where it is separated into a CO₂-enriched stream and an overhead stream comprising a portion of the hydrogen, a portion of the carbon dioxide, and the at least one of methane, carbon monoxide, nitrogen, and argon.

The overhead stream is sent to a second hydrogen PSA unit where it is separated into a second high-pressure hydrogen stream enriched in hydrogen and a low-pressure tail gas stream comprising most of the methane, carbon monoxide, nitrogen, and argon, some hydrogen, and a small portion of the carbon dioxide.

The CO₂-enriched stream from the CO₂ PSA unit, the low-pressure tail gas stream from the second hydrogen PSA unit, and oxygen from an air separation unit are sent to an oxyfuel combustion fired heater, optionally along with supplemental natural gas fuel to produce steam and/or electricity. The flue gas from the fired heater is compressed and dried, providing the CO₂ product stream.

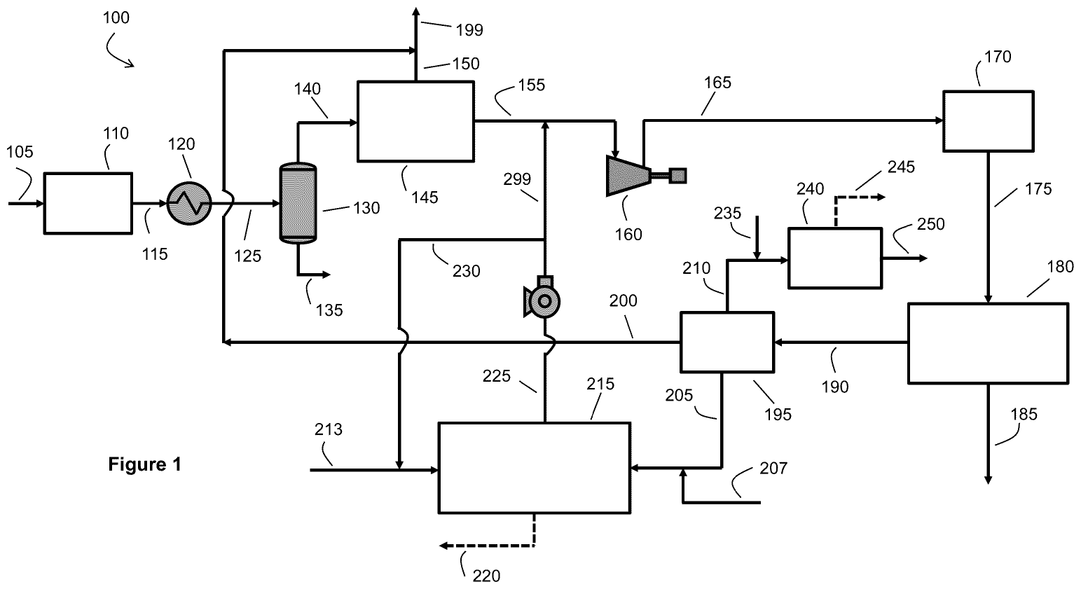

One embodiment of a rich burn process 100 is illustrated in FIG. 1. The feed stream 105 is sent to the hydrogen production process unit 110. The synthesis gas stream 115 is optionally cooled in a cooler 120, and the cooled synthesis gas stream 125 is optionally sent to a knock-out drum 130 where water 135 is separated from the cooled synthesis gas stream 140.

The cooled synthesis gas stream 140 is sent to a hydrogen PSA unit 145 where it is separated into a first high-pressure hydrogen product stream 150 and a hydrogen-depleted tail gas stream 155.

The hydrogen-depleted tail gas stream 155 is compressed in compressor 160 forming a compressed hydrogen-depleted tail gas stream 165 and dried in dryer 170. The dried compressed hydrogen-depleted tail gas stream 175 is sent to the CO₂ fractionation system 180 where it is separated into a CO₂-enriched product stream 185 and an overhead stream 190. The overhead stream 190 is sent to an overhead PSA system 195 and separated into a second high-pressure hydrogen product stream 200, a low-pressure tail gas stream 205, and a vent gas stream 210. The second high-pressure hydrogen product stream 200 is combined with the first high-pressure hydrogen product stream 150 and recovered as combined hydrogen product stream 199.

The low-pressure tail gas stream 205, a natural gas stream 207, and oxygen stream 213 are sent to a first fired heater 215 and combusted to produce steam and/or electricity 220.

The flue gas stream 225 from the first fired heater 215 is sent to the compressor 160 along with the hydrogen-depleted tail gas stream 155. A portion 230 of the flue gas stream 225 may be recycled to the first fired heater to control the temperature of the combustion in the fired heater (e.g., an adiabatic flame temperature of 1500° C. to 2500° C.).

The vent gas stream 210 and air stream 235 are sent to a second fired heater 240 to produce stream and/or electricity 245 and a second flue gas stream 250. The second flue gas stream 250 is vented to the atmosphere.

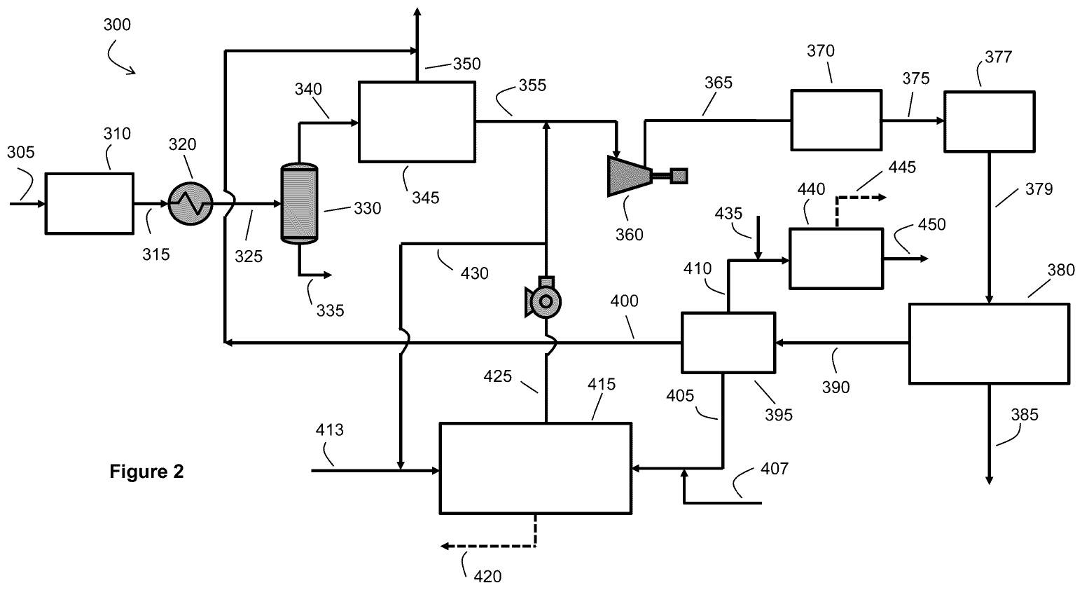

One embodiment of a lean burn process 300 is illustrated in FIG. 2. The feed stream 305 is sent to the hydrogen production process unit 310. The synthesis gas stream 315 is optionally cooled in a cooler 320, and the cooled synthesis gas stream 325 is optionally sent to a knock-out drum 330 where water 335 is separated from the cooled synthesis gas stream 340.

The cooled synthesis gas stream 340 is sent to a hydrogen PSA unit 345 where it is separated into a first high-pressure hydrogen product stream 350 and a hydrogen-depleted tail gas stream 355.

The hydrogen-depleted tail gas stream 355 is compressed in compressor 360 forming a compressed hydrogen-depleted tail gas stream 365 and dried in dryer 377. Before drying, the compressed hydrogen-depleted tail gas stream 365 is sent to a de-oxidation (DeOxo) unit 370. The de-oxidized and dried hydrogen-depleted tail gas stream 379 is sent to the CO₂ fractionation system 380 where it is separated into a CO₂-enriched product stream 385 and an overhead stream 390. The overhead stream 390 is sent to an overhead PSA system 395 and separated into a second high-pressure hydrogen product stream 400, a low-pressure tail gas stream 405, and a vent gas stream 410. The second high-pressure hydrogen product stream 400 is recovered along with the first high-pressure hydrogen product stream 350.

The low-pressure tail gas stream 405, a natural gas stream 407, and oxygen stream 413 are sent to a first fired heater 415 and combusted to produce steam and/or electricity 420.

The flue gas stream 425 from the first fired heater 415 is sent to the compressor 360 along with the hydrogen-depleted tail gas stream 355. A portion 430 of the flue gas stream 425 may be recycled to the first fired heater 415.

The vent gas stream 410 and air stream 435 are sent to a second fired heater 440 to produce stream and/or electricity 445 and a second flue gas stream 450.

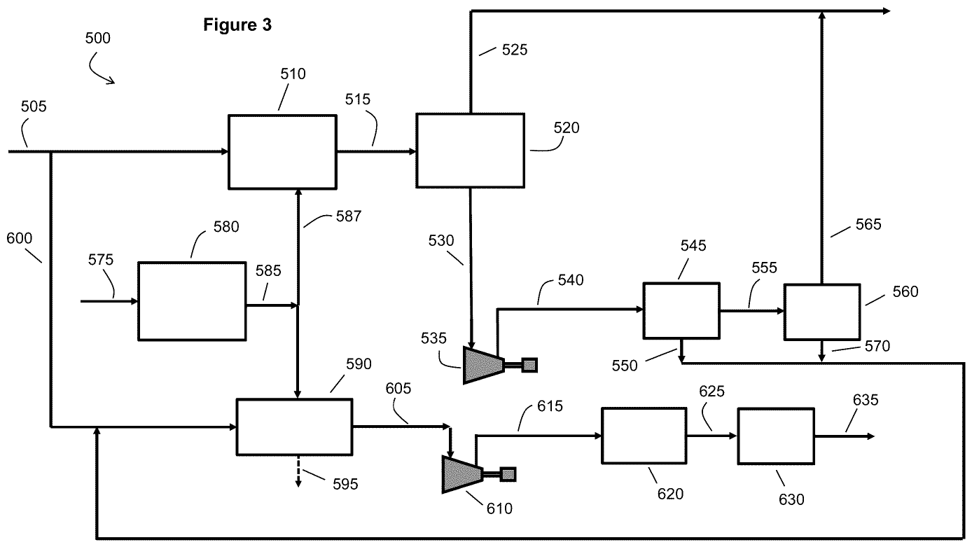

FIG. 3 illustrates an embodiment of a process 500 including a CO₂ PSA unit. The hydrocarbon feed stream 505 is sent to the hydrogen production process unit 510 where it is converted to synthesis gas stream 515. The synthesis gas stream 515 is sent to a hydrogen PSA unit 520 where it is separated into a first high-pressure hydrogen product stream 525 and a hydrogen-depleted tail gas stream 530. The hydrogen-depleted tail gas stream 530 is compressed in compressor 535. The compressed hydrogen-depleted tail gas stream 540 is sent to a CO₂ PSA unit 545 where it is separated into CO₂-enriched stream 550 and an overhead stream 555. The overhead stream 555 is sent to a hydrogen PSA unit 560 and separated into a second high-pressure hydrogen stream 565 and a low-pressure tail gas stream 570.

The first high-pressure hydrogen product stream 525 and second high-pressure hydrogen stream 565 are recovered.

An air stream 575 is separated in an air separation unit 580 into an oxygen stream 585 and a nitrogen stream. The air separation unit 580 can be a cryogenic separation unit, for example. In some embodiments, a portion 587 of oxygen stream 585 can be sent to the hydrogen production process unit 510.

The CO₂-enriched stream 550, low-pressure tail gas stream 570, and oxygen stream 585 are sent to a fired heater 590 to produce steam and/or electricity 595. Optionally, a portion 600 of the hydrocarbon feed stream 505 can also be sent to the fired heater 590 as additional fuel.

The flue gas 605 from the fired heater 590 is compressed in compressor 610, and the compressed flue gas 615 is dried in dryer 630. The compressed, dried flue gas 635 can be recovered as the product CO₂ stream.

Alternatively, in some embodiments, a de-oxidation (DeOxo) unit 620 is used upstream of the dryer 630 to remove oxygen, and the de-oxidized flue gas stream 635 is recovered as the product CO₂ stream.

### EXAMPLE

An example of the process in FIG. 1 for hydrogen and carbon dioxide recovery from an autothermal reforming process is given below in Table 1. Stream numbers in Table 1 correspond to stream numbers in FIG. 1. In this example, natural gas is the feedstock to the autothermal reforming process, and natural gas is also used as supplemental fuel gas (natural gas stream 207) in the oxyfuel combustion fired heater 215.

The results in Table 1 show that there are no direct CO₂ emissions to the atmosphere associated with flue gas streams 225 and 250. The heat generated in fired heater 215 and fired heater 240 provides about 80 MW of heat duty (lower heating value basis) for generation of high-pressure steam. This high-pressure steam is sufficient for the upstream autothermal reforming process, and this steam is also used to generate electricity in a steam turbine. The electricity generated in the steam turbine is enough to supply the entire power demand for the CO₂ capture and hydrogen recovery process shown in FIG. 1. Thus, the entire process in FIG. 1 is self-sufficient, with no direct CO₂ emissions to the atmosphere.

TABLE 1
Example

| | Stream ID | | | | | | | |
|---|---|---|---|---|---|---|---|---|
| | 140 | 199 | 210 | 185 | 205 | 207 | 213 | 299 |
| Molar Flow, gmol/hr | 6165 | 4467 | 54.7 | 1874 | 276.6 | 293.5 | 675.9 | 565.9 |
| Mass Flow, MT/hr | 78.0 | 9.09 | 0.47 | 82.2 | 8.52 | 4.71 | 21.6 | 23.3 |
| Pressure, bara | 31.7 | 30.3 | 2.8 | 187 | 1.35 | 2.8 | 2.8 | 1.35 |
| Temp. ° C. | 40 | 40 | 40 | 34 | 20 | 40 | 40 | 65 |
| Composition, mol % | | | | | | | | |
| Methane | 0.50 | 0.00 | 0.00 | 0.38 | 10.79 | 100.00 | 0.00 | 1.10 |
| Hydrogen | 73.82 | 99.94 | 75.72 | 0.00 | 16.04 | 0.00 | 0.00 | 0.00 |
| CO₂ | 24.47 | <10 ppmv | 0.00 | 99.50 | 51.08 | 0.00 | 0.00 | 87.86 |
| Carbon Monoxide | 0.64 | <20 ppmv | 0.00 | 0.02 | 14.10 | 0.00 | 0.00 | 0.00 |
| N₂ | 0.21 | 0.02 | 21.83 | 0.01 | 7.32 | 0.00 | 0.00 | 3.57 |
| Argon | 0.06 | 0.04 | 2.45 | 0.04 | 0.67 | 0.00 | 0.00 | 0.33 |
| Water | 0.26 | <5 ppmv | 0.00 | <50 ppmv | 0.00 | 0.00 | 0.00 | 7.14 |
| Methanol | 0.04 | — | — | 0.04 | 0.00 | 0.00 | 0.00 | — |
| Ammonia | 32 ppmv | — | — | 0.01 | 0.00 | 0.00 | 0.00 | — |
| Oxygen | 0.00 | 0.00 | 0.00 | 0.00 | 0.00 | 0.00 | 100.00 | 0.00 |
| Total | 100.00 | 100.00 | 100.00 | 100.00 | 100.00 | 100.00 | 100.00 | 100.00 |

### SPECIFIC EMBODIMENTS

While the following is described in conjunction with specific embodiments, it will be understood that this description is intended to illustrate and not limit the scope of the preceding description and the appended claims.

A first embodiment of the invention is a method of producing a hydrogen-enriched product and recovering CO₂ comprising processing a feed stream comprising hydrocarbons or a carbonaceous feedstock in a hydrogen production process unit to produce a synthesis gas stream comprising hydrogen, carbon dioxide, and at least one of carbon monoxide, methane, water, nitrogen, and argon; separating the synthesis gas stream in a hydrogen pressure swing adsorption (PSA) unit into a first high-pressure hydrogen stream enriched in hydrogen and a hydrogen depleted tail gas stream comprising a portion of the hydrogen, the carbon dioxide, and the at least one of the methane, the carbon monoxide, the water, the nitrogen, and the argon; compressing the hydrogen depleted tail gas stream in a compressor to form a compressed tail gas stream; separating the compressed tail gas stream in a CO₂ fractionation system into a CO₂-enriched product stream comprising a first portion of the carbon dioxide and an overhead stream comprising the portion of the hydrogen, a second portion of the carbon dioxide, and the at least one of the methane, the carbon monoxide, the nitrogen, and the argon; separating the overhead stream from the CO₂ fractionation system in an overhead hydrogen PSA system into at least a second high-pressure hydrogen stream enriched in hydrogen, and a low-pressure tail gas stream comprising the second portion of the carbon dioxide, the methane, the carbon monoxide, and a first portion of the nitrogen and the argon; recovering the first and second high-pressure hydrogen streams and the CO₂-enriched product stream; combusting the low-pressure tail gas stream from the overhead hydrogen PSA system and oxygen in a first fired heater to produce steam, electricity, or both and a first flue gas stream. An embodiment of the invention is one, any or all of prior embodiments in this paragraph up through the first embodiment in this paragraph further comprising recycling at least a first portion of the first flue gas to the first fired heater; or introducing at least a second portion of the first flue gas to the CO₂ fractionation system; or both. An embodiment of the invention is one, any or all of prior embodiments in this paragraph up through the first embodiment in this paragraph wherein separating the overhead stream from the CO₂ fractionation system in the overhead hydrogen PSA system comprises separating the overhead stream from the CO₂ fractionation system into at least the second high-pressure hydrogen stream enriched in hydrogen, the low-pressure tail gas stream, and a vent gas stream comprising a portion of the hydrogen, at least a second portion of the nitrogen and the argon in the overhead stream, and further comprising combusting the vent gas stream with air in a second fired heater to produce steam, electricity, or both and a second flue gas stream; or introducing the vent gas into a fuel header; or both. An embodiment of the invention is one, any or all of prior embodiments in this paragraph up through the first embodiment in this paragraph further comprising removing oxygen from the compressed tail gas stream before separating the compressed tail gas stream. An embodiment of the invention is one, any or all of prior embodiments in this paragraph up through the first embodiment in this paragraph further comprising introducing natural gas into the first fired heater. An embodiment of the invention is one, any or all of prior embodiments in this paragraph up through the first embodiment in this paragraph further comprising venting a portion of the first flue gas stream to the atmosphere. An embodiment of the invention is one, any or all of prior embodiments in this paragraph up through the first embodiment in this paragraph further comprising drying the compressed tail gas stream before separating the compressed tail gas stream in the CO₂ fractionation system. An embodiment of the invention is one, any or all of prior embodiments in this paragraph up through the first embodiment in this paragraph wherein the overhead hydrogen PSA system comprises a three-product PSA unit. An embodiment of the invention is one, any or all of prior embodiments in this paragraph up through the first embodiment in this paragraph further comprising compressing a portion of the tail-gas stream from the overhead hydrogen PSA system and mixing the portion with the CO₂-enriched product stream. An embodiment of the invention is one, any or all of prior embodiments in this paragraph up through the first embodiment in this paragraph further comprising chilling the synthesis gas stream and removing a portion of the water from the synthesis gas stream before separating the synthesis gas stream in the hydrogen high pressure PSA unit. An embodiment of the invention is one, any or all of prior embodiments in this paragraph up through the first embodiment in this paragraph wherein the overhead hydrogen PSA system comprises a three-product PSA unit or two PSA units in series.

A second embodiment of the invention is a method of producing a hydrogen-enriched product and recovering CO₂ comprising processing a feed stream comprising hydrocarbons or a carbonaceous feedstock in a hydrogen production process unit to produce a synthesis gas stream comprising hydrogen, carbon dioxide, and at least one of carbon monoxide, methane, water, nitrogen, and argon; separating the synthesis gas stream in a hydrogen pressure swing adsorption (PSA) unit into a first high-pressure hydrogen stream enriched in hydrogen and a hydrogen-depleted tail gas stream comprising a portion of the hydrogen, the carbon dioxide, the water, and the at least one of the methane, the carbon monoxide, the nitrogen, and the argon; compressing the hydrogen depleted tail gas stream in a compressor to form a compressed tail gas stream; separating the compressed tail gas stream in a CO₂ PSA unit into a CO₂-enriched stream and an overhead stream comprising the portion of the hydrogen, a portion of the carbon dioxide, and the at least one of the methane, the carbon monoxide, the nitrogen, and the argon; separating the overhead stream from the CO₂ PSA unit in a second hydrogen PSA unit into a second high-pressure hydrogen stream enriched in hydrogen, and a low-pressure tail gas stream comprising the at least one of the methane, the carbon monoxide, the nitrogen, and the argon, and a portion of the carbon dioxide; recovering the first and second high-pressure hydrogen streams; separating air in an air separation unit to produce an oxygen stream; introducing a natural gas stream, the CO₂-enriched stream, the low-pressure tail gas stream from the second hydrogen PSA unit, and the oxygen stream from the air separation unit into a fired heater to produce steam, electricity, or both and a flue gas stream comprising the carbon dioxide; compressing and drying the flue gas stream; and recovering the compressed flue gas stream as a CO₂ product stream. An embodiment of the invention is one, any or all of prior embodiments in this paragraph up through the second embodiment in this paragraph further comprising removing oxygen from the compressed flue gas stream before recovering the compressed flue gas stream. An embodiment of the invention is one, any or all of prior embodiments in this paragraph up through the second embodiment in this paragraph further comprising introducing a portion of the oxygen stream from the air separation unit into the hydrogen production process unit.

Without further elaboration, it is believed that using the preceding description that one skilled in the art can utilize the present invention to its fullest extent and easily ascertain the essential characteristics of this invention, without departing from the spirit and scope thereof, to make various changes and modifications of the invention and to adapt it to various usages and conditions. The preceding preferred specific embodiments are, therefore, to be construed as merely illustrative, and not limiting the remainder of the disclosure in any way whatsoever, and that it is intended to cover various modifications and equivalent arrangements included within the scope of the appended claims.

In the foregoing, all temperatures are set forth in degrees Celsius and, all parts and percentages are by weight, unless otherwise indicated.

What is claimed is:

1. A method of producing a hydrogen-enriched product and recovering CO₂ comprising:
processing a feed stream comprising hydrocarbons or a carbonaceous feedstock in a hydrogen production process unit to produce a synthesis gas stream comprising hydrogen, carbon dioxide, and at least one of carbon monoxide, methane, water, nitrogen, and argon;
separating the synthesis gas stream in a hydrogen pressure swing adsorption (PSA) unit into a first high-pressure hydrogen stream enriched in hydrogen and a hydrogen depleted tail gas stream comprising a portion of the hydrogen, the carbon dioxide, and the at least one of the methane, the carbon monoxide, the water, the nitrogen, and the argon;
compressing the hydrogen depleted tail gas stream in a compressor to form a compressed tail gas stream;
separating the compressed tail gas stream in a CO₂ fractionation system into a CO₂-enriched product stream comprising a first portion of the carbon dioxide and an overhead stream comprising the portion of the hydrogen, a second portion of the carbon dioxide, and the at least one of the methane, the carbon monoxide, the nitrogen, and the argon;
separating the overhead stream from the CO₂ fractionation system in an overhead hydrogen PSA system into at least a second high-pressure hydrogen stream enriched in hydrogen, and a low-pressure tail gas stream comprising the second portion of the carbon dioxide, the methane, the carbon monoxide, and a first portion of the nitrogen and the argon;
recovering the first and second high-pressure hydrogen streams and the CO₂-enriched product stream; and
combusting the low-pressure tail gas stream from the overhead hydrogen PSA system and oxygen in a first fired heater to produce steam, electricity, or both and a first flue gas stream.

2. The method of claim 1 further comprising:
recycling at least a first portion of the first flue gas to the first fired heater; or
introducing at least a second portion of the first flue gas to the CO₂ fractionation system;
or both.

3. The method of claim 1 wherein separating the overhead stream from the CO₂ fractionation system in the overhead hydrogen PSA system comprises separating the overhead stream from the CO₂ fractionation system into at least the second high-pressure hydrogen stream enriched in hydrogen, the low-pressure tail gas stream, and a vent gas stream comprising a portion of the hydrogen, at least a second portion of the nitrogen and the argon in the overhead stream, and further comprising:
combusting the vent gas stream with air in a second fired heater to produce steam, electricity, or both and a second flue gas stream; or
introducing the vent gas into a fuel header; or
both.

4. The method of claim 1 further comprising:
removing oxygen from the compressed tail gas stream before separating the compressed tail gas stream.

5. The method of claim 1 further comprising:
introducing natural gas into the first fired heater.

6. The method of claim 1 further comprising:
venting a portion of the first flue gas stream to the atmosphere.

7. The method of claim 1 further comprising:
drying the compressed tail gas stream before separating the compressed tail gas stream in the CO₂ fractionation system.

8. The method of claim 1 wherein the overhead hydrogen PSA system comprises a three-product PSA unit.

9. The method of claim 1 further comprising:
compressing a portion of the tail-gas stream from the overhead hydrogen PSA system and mixing the portion with the CO₂-enriched product stream.

10. The method of claim 1 further comprising:
chilling the synthesis gas stream and removing a portion of the water from the synthesis gas stream before separating the synthesis gas stream in the hydrogen high pressure PSA unit.

11. The method of claim 1 wherein the overhead PSA system comprises a three-product PSA unit or two PSA units in series.

12. A method of producing a hydrogen-enriched product and recovering CO₂ comprising:
processing a feed stream comprising hydrocarbons or a carbonaceous feedstock in a hydrogen production process unit to produce a synthesis gas stream comprising hydrogen, carbon dioxide, and at least one of carbon monoxide, methane, water, nitrogen, and argon;
separating the synthesis gas stream in a hydrogen pressure swing adsorption (PSA) unit into a first high-pressure hydrogen stream enriched in hydrogen and a hydrogen-depleted tail gas stream comprising a portion of the hydrogen, the carbon dioxide, the water, and the at least one of the methane, the carbon monoxide, the nitrogen, and the argon;
compressing the hydrogen depleted tail gas stream in a compressor to form a compressed tail gas stream;
separating the compressed tail gas stream in a CO₂ PSA unit into a CO₂-enriched stream and an overhead stream comprising the portion of the hydrogen, a portion of the carbon dioxide, and the at least one of the methane, the carbon monoxide, the nitrogen, and the argon;
separating the overhead stream from the CO₂ PSA unit in a second hydrogen PSA unit into a second high-pressure hydrogen stream enriched in hydrogen, and a low-pressure tail gas stream comprising the at least one of the methane, the carbon monoxide, the nitrogen, and the argon, and a portion of the carbon dioxide;
recovering the first and second high-pressure hydrogen streams;
separating air in an air separation unit to produce an oxygen stream;
introducing a natural gas stream, the CO₂-enriched stream, the low-pressure tail gas stream from the second hydrogen PSA unit, and the oxygen stream from the air separation unit into a fired heater to produce steam, electricity, or both and a flue gas stream comprising the carbon dioxide;
compressing and drying the flue gas stream; and
recovering the compressed flue gas stream as a CO₂ product stream.

13. The method of claim 12 further comprising:
removing oxygen from the compressed flue gas stream before recovering the compressed flue gas stream.

14. The method of claim 12 further comprising:
introducing a portion of the oxygen stream from the air separation unit into the hydrogen production process unit.
